(19) United States
(12) Patent Application Publication
(10) Pub. No.: US 2018/0163396 A1
(43) Pub. Date: Jun. 14, 2018

(54) MOLDED INSULATION PANELS FOR A METAL ROOF

(71) Applicant: Jerramy J. Boyles, Rockwall, TX (US)

(72) Inventor: Jerramy J. Boyles, Rockwall, TX (US)

(21) Appl. No.: 15/834,213

(22) Filed: Dec. 7, 2017

Related U.S. Application Data
(60) Provisional application No. 62/433,283, filed on Dec. 13, 2016.

(51) Int. Cl. E04B 1/80; B32B 3/28; B32B 5/18; B32B 15/04

(52) U.S. Cl. CPC E04B 1/80; B32B 3/28; E04B 1/7608; B32B 15/046; B32B 5/18

(57) ABSTRACT

An insulation panel for a metal roof and method of fabrication thereof is provided. The insulation panel includes a body formed of a moldable insulating material, the body having a first surface facing away from the metal roof panel to which the body is to be applied on and a second surface opposed from the first surface and configured to mate with the metal roof, wherein the second surface of the body comprises a non-planar surface shaped to conform to a profile of the metal roof. The insulation panel is thus provided as an integrally formed panel that may be form-fitted to the specific metal roof panel type to which it is to be applied, so as to reduce materials costs and installation costs associated therewith and provide an increased R value associated with the panel.

### CROSS REFERENCE TO RELATED APPLICATION

The present invention is a non-provisional of, and claims priority to, U.S. Provisional Patent Application Ser. No. 62/433,283, filed Dec. 13, 2016, the disclosure of which is incorporated herein by reference in its entirety.

### BACKGROUND OF THE INVENTION

The invention relates generally to insulation panels for metal roofing and, more particularly, to a molded insulation panel that is constructed to conform to a profile of the metal roof to which the molded insulation panel is applied.

It is common practice for many industrial buildings, warehouses, and the like to have roofs constructed of self-supportive structural roof panels of metal, such as aluminum or galvanized steel—i.e., “R panel roofing.” This type of roof has little or no insulation value, such that the structure covered by the roof may be prone to high levels of heating in the summer and high levels of cooling in the winter. During hot weather, it is well known that a metal roof will actually increase the interior temperature of a building to a point higher than the ambient temperature due to the heat sink characteristics thereof. It is thus apparent that insulating this type of a roof will pay great dividends in providing greater comfort to workers/occupants in such buildings and in preventing damage to stored goods which may be sensitive to temperature and humidity.

One common system for providing insulation to metal roofs is by way of a thermoplastic polyolefin (TPO) type roof system. The TPO roof system includes a thin TPO membrane that is laid on top of a built-up roof structure of corrugated metal panels, rigid foam insulation, and roofing board. In building-up the TPO roof system on the existing metal R panels, strips of expanded polystyrene (EPS) or “flute fillers,” are positioned within voids or valleys present between raised ridges of the metal roof panels in order to fill-in the voids and present a uniform and level substrate. Sheets of insulation board or decking that are typically formed of extruded polystyrene (XPS), e.g., Isoboard®, are then applied over the level substrate presented by the metal roof panel ridges and flute fillers, with the TPO membrane finally being applied over the insulation board/decking to complete the formation of the TPO roof system on the metal roof.

While the existing use and application of separate flute fillers and insulation board/decking in forming a roof insulating system is recognized as providing an insulating roof system with adequate longevity and insulative properties, it is not without its drawbacks. More specifically, the use of separate flute fillers and insulation board/decking in forming the roof insulating system results in increased materials costs as well as increased labor costs—due to the required two-step application process of the separate flute fillers and insulation board/decking. Additionally, it is recognized that the use of separate flute fillers and insulation board/decking results in small open spaces remaining between the flute fillers and the metal panels, as the flute fillers are stock insulation strips (e.g., 8′×9″ strips) that may not conform completely to the metal roof panels—such that the R value of the roof insulating system may be reduced.

It would therefore be desirable to provide a roof insulating system that includes insulating materials having reduced materials costs and installation costs associated therewith. It would further be desirable for such a roof insulating system to have increased efficiency of the R value associated with the product.

### BRIEF DESCRIPTION OF THE INVENTION

Embodiments of the invention provide a molded insulation panel that is constructed to conform to a profile of the metal roof to which the molded insulation panel is applied.

In accordance with one aspect of the invention, an insulation panel for a metal roof includes a body formed of a moldable insulating material, the body having a first surface facing away from a metal roof panel to which the body is to be applied on and a second surface opposed from the first surface and configured to mate with the metal roof panel to which the body is to be applied on, wherein the second surface of the body comprises a non-planar surface shaped to conform to a profile of the metal roof panel to which the body is to be applied on.

In accordance with another aspect of the invention, a roofing system includes a metal roof having at least one non-planar surface and an insulation panel applied to the non-planar surface of the metal roof, the insulation panel comprising a body formed of a moldable insulating material and including a planar first surface facing away from the metal roof and a second surface opposed from the first surface and configured to mate with the metal roof, wherein the second surface of the body comprises a non-planar surface shaped to conform to a profile of the non-planar surface of the metal roof.

In accordance with yet another aspect of the invention, a method of fabricating an insulation panel for a metal roof includes determining a profile of a metal decking panel to which the insulation panel is to be applied and fabricating the insulation panel via a molding process and such that the insulation panel is form-fitted to the profile of the metal decking panel, with the insulation panel being fabricated to include a planar first surface facing away from the metal decking panel to which the insulation panel is to be applied on and a non-planar second surface opposed from the first surface and configured to be form-fitted with the metal decking panel.

### BRIEF DESCRIPTION OF THE DRAWINGS

The drawings illustrate embodiments presently contemplated for carrying out the invention.

In the drawings:

FIG. 1 is a cross-sectional elevation view of a roof system with which embodiments of the invention could be implemented.

FIG. 2 is a perspective view of a molded insulating panel coupled to a metal roofing panel, according to an embodiment of the invention.

FIG. 3 is a perspective view of a molded insulating panel, according to an embodiment of the invention.

FIGS. 4A-4R are side view of various exposed fastener roofing panels to which molded insulating panels may be conformed, according to an embodiment of the invention.

FIGS. 5A-5C are side view of various structural flat pan standing seam roof panels to which molded insulating panels may be conformed, according to an embodiment of the invention.

FIGS. 6A-6M are side view of various commercial standing seam (CSS) roof panels to which molded insulating panels may be conformed, according to an embodiment of the invention.

FIG. 7 is a flowchart illustrating a method of installing a roof insulating system, including fabrication of insulation panels as shown in FIGS. 2 and 3, according to an embodiment of the invention.

### DETAILED DESCRIPTION

Embodiments of the invention provide a molded insulation panel that is constructed to conform to a profile of the metal roof to which the molded insulation panel is applied. The molded insulation panel is composed of an insulation board having a plurality of flute fillers integrally formed therewith on one side of the insulation board. The surface of the insulation board having the plurality of flute fillers thereon forms a non-planar surface shaped to conform to a profile of the metal roof to which the molded insulation panel is to be applied on.

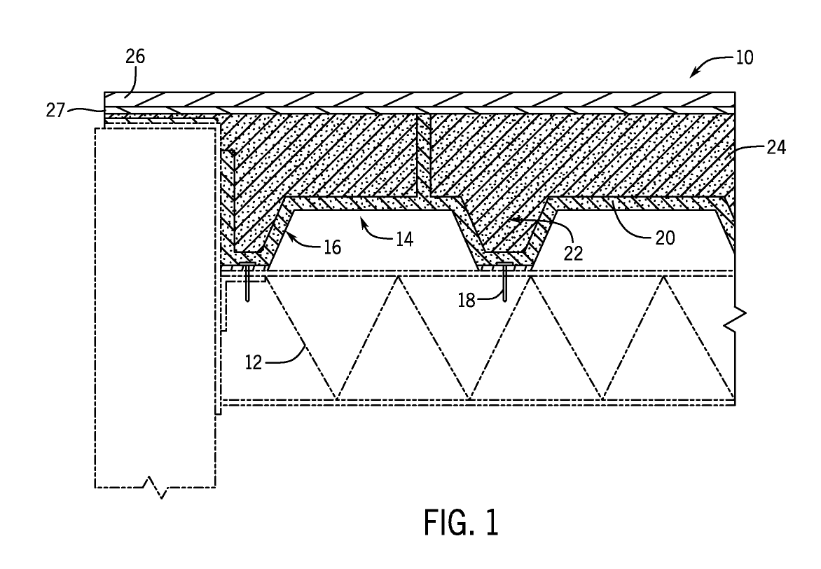

Referring to FIG. 1, a roof insulating system 10 is shown according to an embodiment of the invention. The roof insulating system 10 is supported by an underlying building having joists or purlins 12. A roof deck 14 comprised of a plurality of panels 16 of metal corrugated roof decking material is fastened to the underlying support structure by conventional means such as fasteners 18. As corrugated metal decking or any other modular decking material has panels 16 of a certain size and shape, it is recognized that the decking presents a non-planar surface onto which the roof insulating system 10 is to be applied. In the embodiment shown in FIG. 1, the panels 16 are constructed/shaped such that a plurality of ridges 20 are present thereon between which a plurality of voids or flutes 22 are formed—with the ridges and valleys sometimes being referred to as “high flutes” and “low flutes,” respectively. In general, the metal decking panels 16 utilized for metal buildings are generally configured with the high flute being narrow and the low flute being relatively wide, which in the industry tends to be 12 to 16 inches in width.

According to embodiments of the invention, the roof insulating system 10 includes insulation panels 24 that are constructed to provide a dual functionality—with each insulation panel acting as flute fillers that are positioned in the low flutes of the metal decking panels 16 and acting as an insulation decking board that presents a level surface on which a finishing membrane 26 (e.g., TPO membrane) can be applied, with the finishing membrane 26 being attached to insulation panels 24 via a known technique, such as ballasting, mechanical attachment, or adhesives—with an adhesive 27 shown in FIG. 1. While the insulation panels 24 provide this dual functionality, it is recognized that each of the insulation panels 24 is formed as a single, integral component or body. According to exemplary embodiments, the integral insulation panel 24 is formed of expanded polystyrene (EPS) or extruded polystyrene (XPS) of a desired weight, with it being recognized that the specific material (and weight) may be selected based on a desired functionality and R-value of the insulation panel. In another embodiment, the integral insulation panel may instead be formed of polyisocyanurate, also referred to as PIR, Poly ISO, or ISO. The insulation panel 24 is formed as a molded component having a profile designed to match and conform to a profile of the metal decking panels 16 to which the insulation panel is to be applied. According to embodiments, an adhesive may be utilized to attach the insulation panel body 24 to the metal decking panels 16 for a fully adhered attachment, or alternatively fasteners may be utilized to attach the insulation panel body to the metal decking panels. In either case, the insulation panel body 24 is affixed to a respective metal decking panel 16 such that no air gaps will remain therebetween, thereby increasing the R value of the roof insulating system.

With regard to the finishing membrane 26, the membrane may be formed of any suitable thermoplastic material. More particularly, the finishing membrane 26 may comprise any type of thermoplastic as is known in the art, or blend of thermoplastics, or blend of thermoplastic with a rubber. Accordingly, the finishing membrane 26 may comprise, for example: a thermoplastic polyolefin (TPO) which is a blend of a thermoplastic resin and uncured, or non-cross-linked, rubber; blends of thermoplastic resins and rubbers in which blends, the rubber phase has been partially or fully cured by a dynamic vulcanization process to form thermoplastic vulcanizates (TPV's); unvulcanized block-copolymers or blends thereof, including by example triblock styrene copolymers (SBC), for example, SBS, SIS, SEBS, and SEPS and the like; and thermoplastic resins such as crystalline or crystallizable polyolefins (e.g., polypropylene and polyethylene), polyimides, polyesters (nylons), poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, and fluorine-containing thermoplastics, and mixtures thereof.

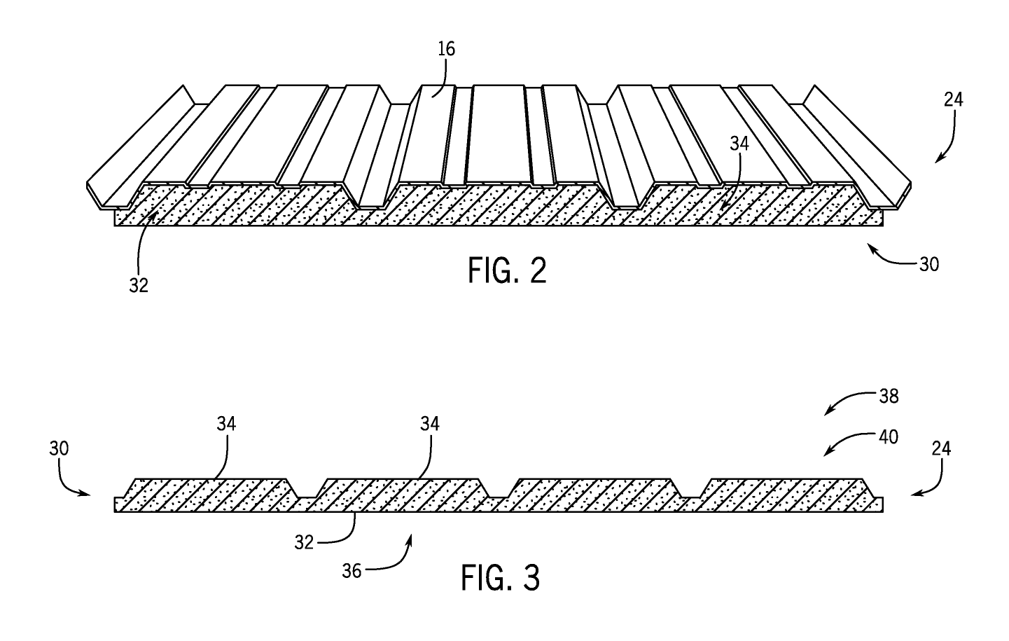

Referring still to FIG. 1, and now additionally to FIGS. 2 and 3, the construction of an insulation panel 24 is described here below in greater detail. The insulation panel is composed of a body 30 formed as a singular structure. As indicated above, the body 30 may be formed via a molding process—such that the shape of the body 30 can be controlled to take any of a number of complex forms and be formed with tight tolerances. The body 30 may generally be described as being composed of an insulation board portion 32 and a flute fillers portion 34 that are formed together as an integral component, as it is recognized that the body 30 of insulation panel provides the dual functionality of acting as flute fillers that are positioned in the low flutes 22 of the metal decking panels 16 and as an insulation decking board that presents a level surface on which a finishing membrane 26 may be applied.

The insulation board portion 32 of the insulation panel includes a first surface 36 and a second surface 38—with the first surface 36 being a planar surface that forms a first surface 36 of the body 30 that faces away from a metal roof panel 16 to which the insulation panel 24 is applied and with the second surface 38 being a surface onto which the flute filler portion 34 of the body 30 is integrally formed. The flute filler portion 34 comprises a plurality of protrusions or flute fillers that are integrally formed on the second surface 38 of the insulation board 24 such that they extend outwardly therefrom—with the second surface 38 of the insulation board 24 and the flute fillers 34 collectively presenting a second surface 40 of the body 30 opposed from the first surface 36 and that is configured to mate with the metal decking panel 16 to which the body 30 is to be applied on. As seen in FIGS. 1-3, the second surface 40 of the body 30 that is formed collectively by the second surface 38 of the insulation board and the flute fillers 34 is a non-planar surface shaped to conform to a profile of the metal roof panel 16 to which the body 30 is to be applied on. In the embodiment of FIGS. 1-3, the flute fillers 34 of the insulation panel body 30 are formed as linear protrusions that are spaced apart in a parallelly arranged fashion. The flute fillers 34 therefore align with the low flutes 22 of the metal decking panels 16 and are shaped to conform to the low flutes 22, such that no gaps will remain between the metal decking panels 16 and the second surface 40 of the insulation panel body 30 when joined together.

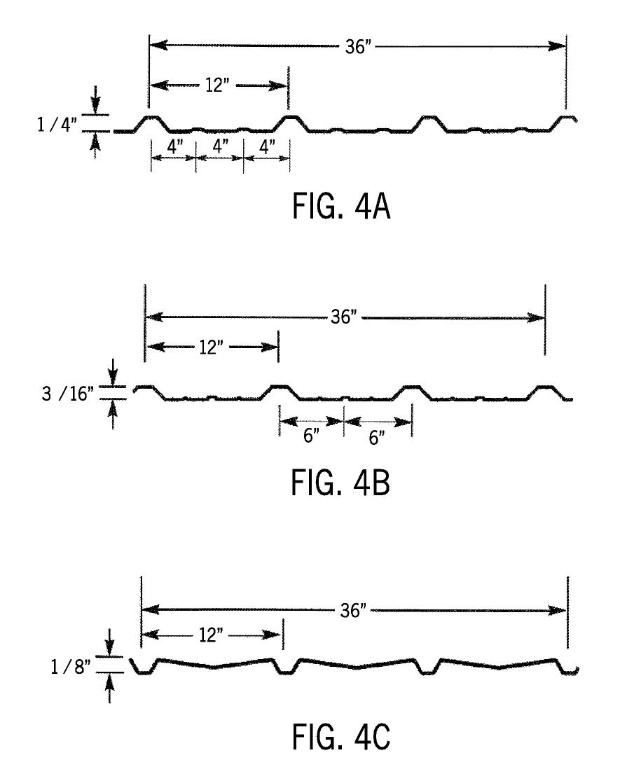

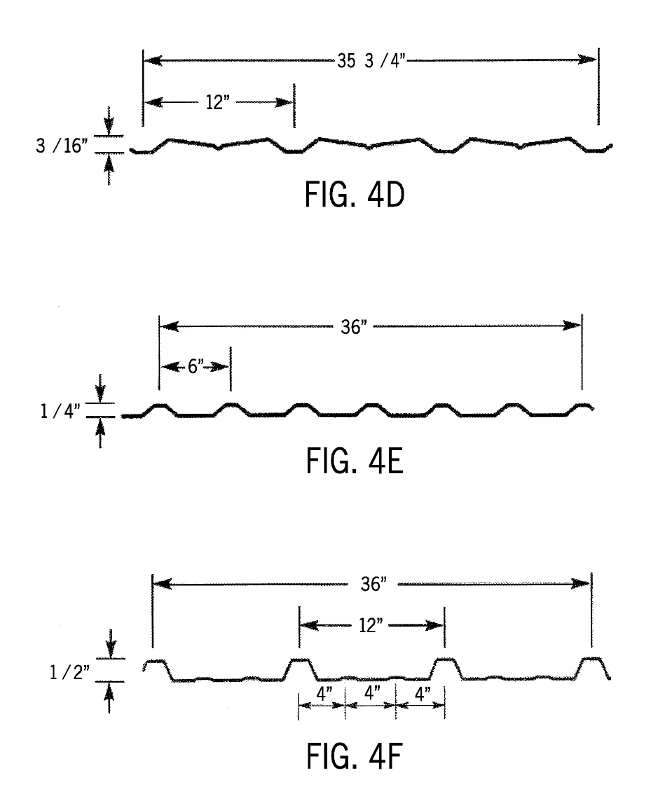

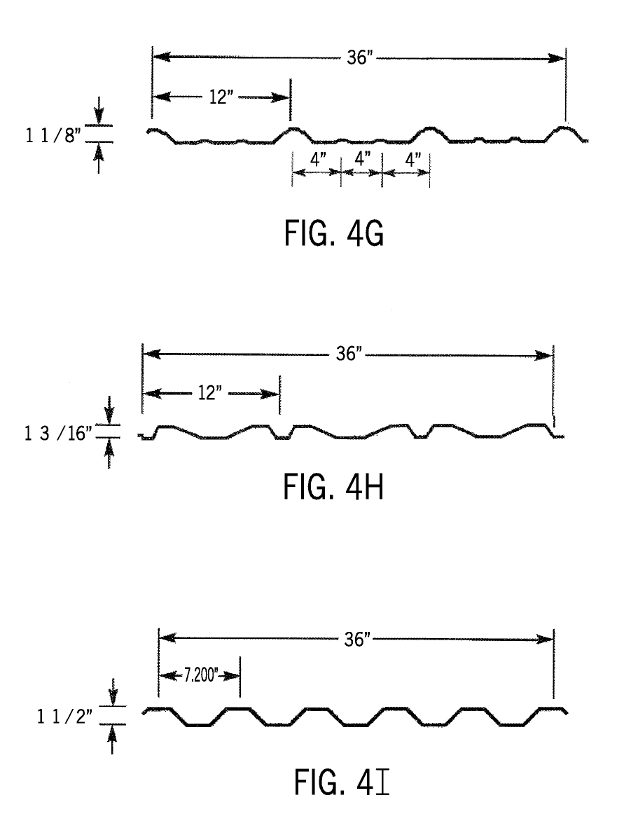

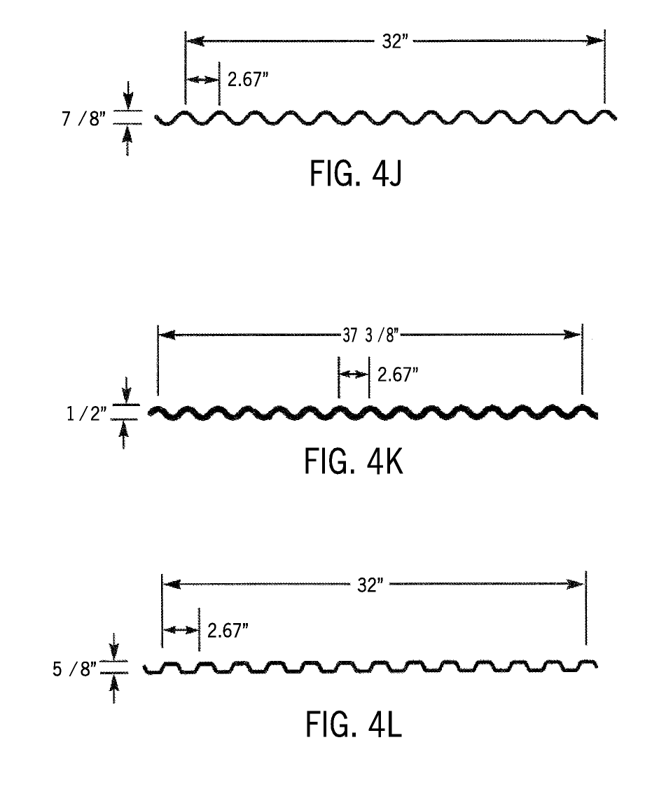

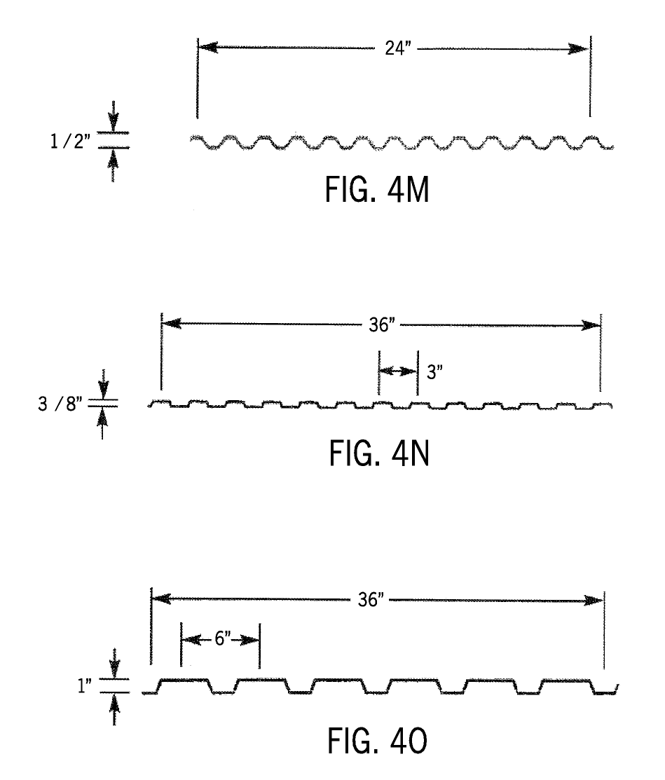

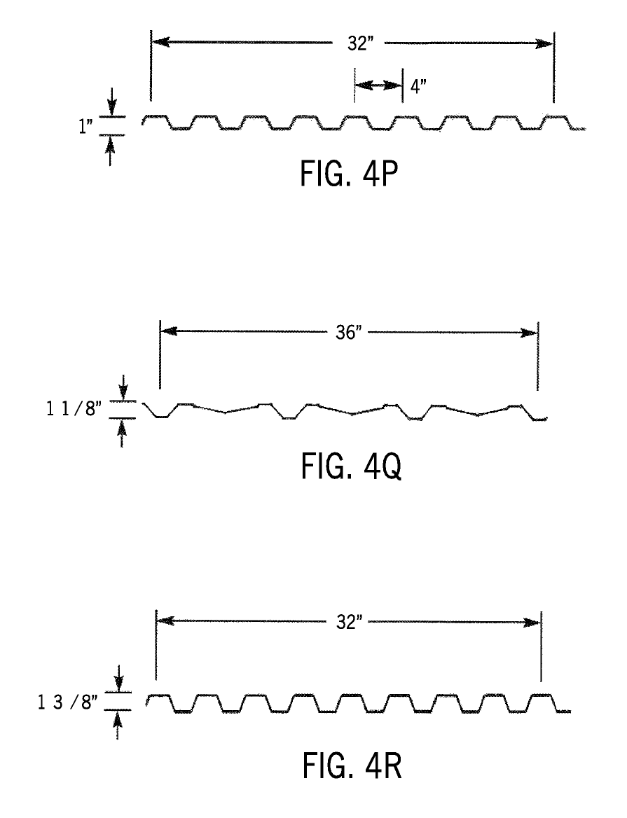

While FIGS. 1-3 illustrate the insulation panel body 30 as including a plurality of flute fillers 34 on the underside thereof that are formed as linear protrusions spaced apart in a parallelly arranged fashion (so as to conform to low flutes of the metal decking panels having the same shape/pattern), it is recognized that embodiments of the invention encompass other insulation panel body designs. That is, the second surface 40 of the insulation panel body 30 may be formed to have any of numerous types of non-planar constructions/patterns that are made to conform to a metal decking panel 16 onto which the insulation panel is to be applied. Examples of other metal decking panel constructions/patterns to which the second surface 40 of insulation panel body 30 can be made to conform are illustrated in FIGS. 4A-4R, 5A-5C, and 6A-6M, and these constructions/patterns may be provided on exposed fastener (EFP) roofing panels, structural flat pan standing seam roof panels, commercial standing seam (CSS) roof panels, and the like.

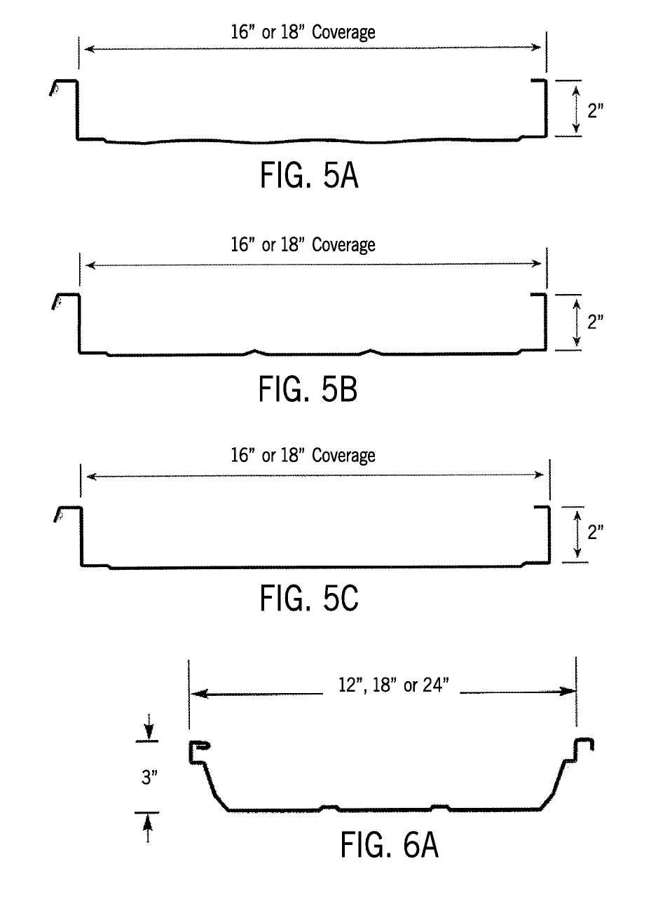

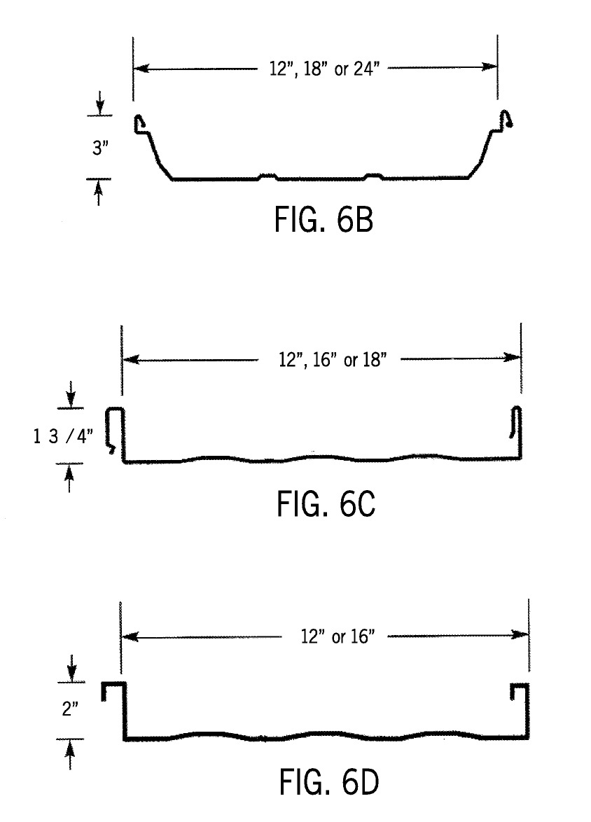

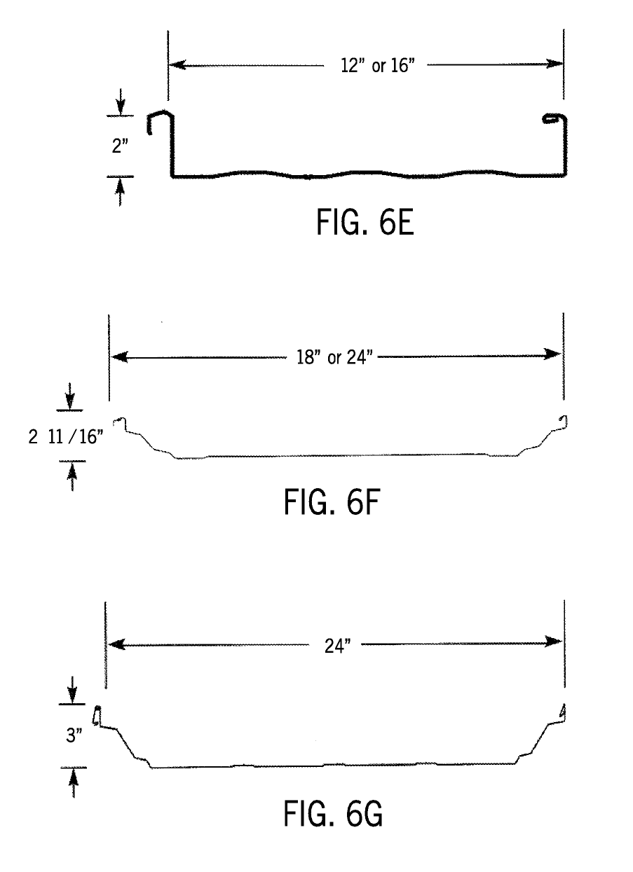

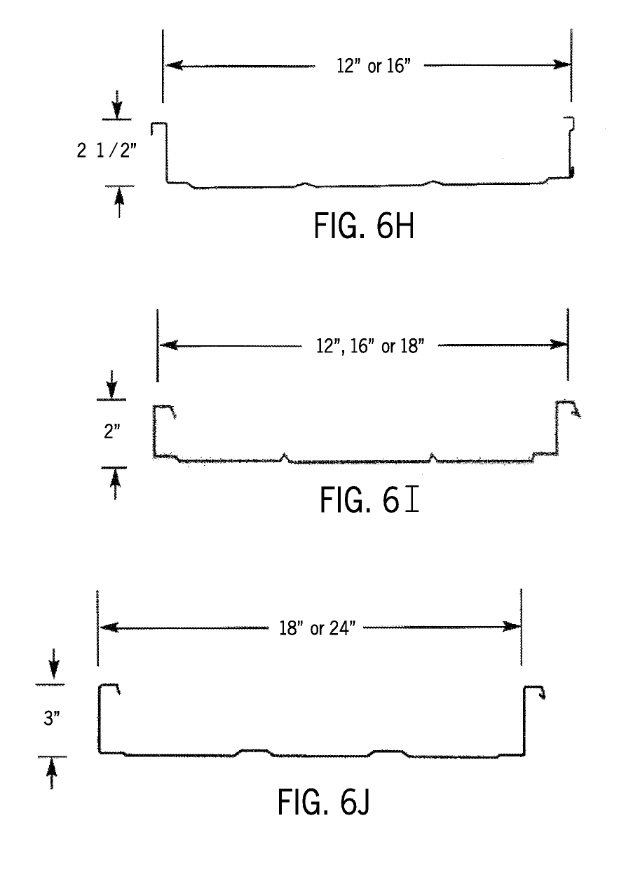

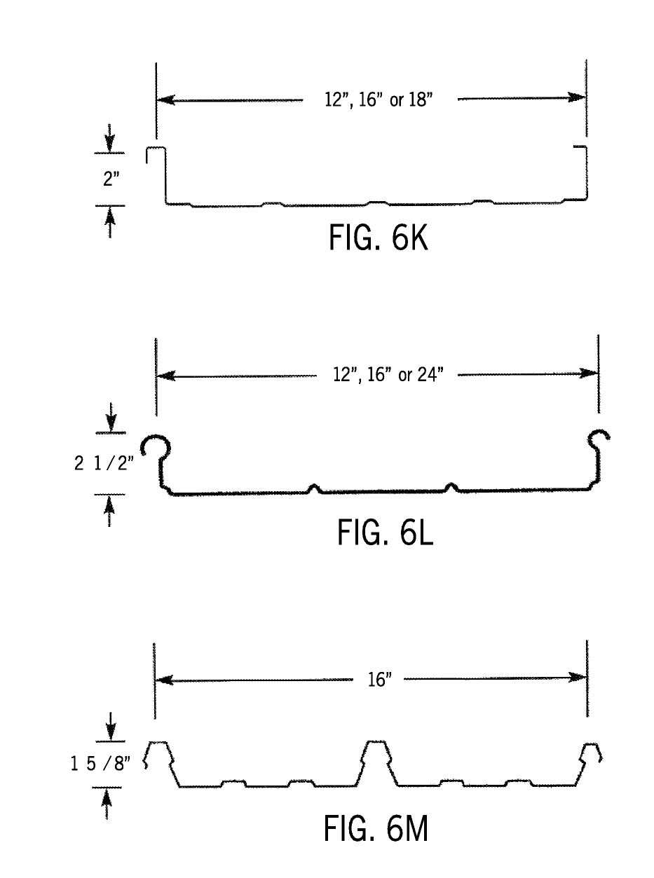

As shown in FIGS. 4A-4R, according to various embodiments, different EFP roofing panels are illustrated having a 24″-36″ width, which is appropriate for a roof application, as well as other wall, soffit, liner, or partition applications. The panels may have an exposed fastener or a semi-concealed fastener profile, with the exposed fastener embodiment being more appropriate for roofing applications. As shown in FIGS. 5A-5C, according to additional embodiments, different structural flat pan standing seam roof panels are illustrated having a 16″-18″ width, which is appropriate for a roof application. Mechanically-seamed, structural standing seam roof panels are ideal for lower sloping and longer spanning roofs. As shown in FIGS. 6A-6M, according to yet additional embodiments, different CSS roofing panels are illustrated having a 12″-24″ width, which is appropriate for a roof application. The panels may have a shan seam profile or mechanically seamed profile that uses an electrical seaming machine that ensures a complete weather-tight connection.

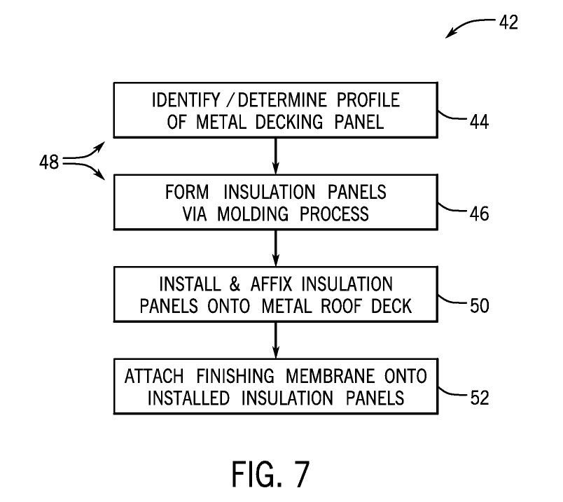

Referring now to FIG. 7, and with reference back to FIGS. 1-3, a method 42 of installing a roof insulating system 10 is shown according to an embodiment of the invention. The method 42 begins at STEPS 44 and 46 as part of a sub-method 48 that results in the fabrication of insulation panels 24 that are part of roof insulating system 10. As part of sub-method 48, the profile of a metal decking panel 16 is first identified/determined at STEP 44. That is, it is recognized that metal decking panels 16 of a corrugated metal decking present a non-planar surface onto which the roof insulating system 10 is to be applied. In one known embodiment, the panels 16 are constructed/shaped such that a plurality of ridges 20 are present thereon between which a plurality of voids or flutes 22 are formed—i.e., “high flutes” and “low flutes.”

Upon a recognition of the profile of the panels 16 to which the roof insulating system 10 is to be applied, the sub-method 48 continues at STEP 46 with the fabrication of insulation panels 24. According to an exemplary embodiment, the insulation panels 24 are formed via a molding process such that the panel includes a planar or flat top surface and a bottom surface having a profile designed to match and conform to the profile of the metal decking panels 16 to which the insulation panel is to be applied. The molding of the insulation panels 24 allows for the shape of the panels to be controlled to take any of a number of complex forms and for the panels to be formed with tight tolerances. The insulation panels 24 may generally be described as being composed of an insulation board portion 32 and a flute fillers portion 34 that are formed together as an integral component, as it is recognized that the body 30 of insulation panel 24 provides the dual functionality of acting as flute fillers that are positioned in the low flutes 22 of the metal decking panels 16 and as an insulation decking board that presents a level surface on which a finishing membrane may be applied.

Upon completion of sub-method 48 that provides fabricated insulation panels 24, the method continues at STEP 50 by installing the insulation panels 24 onto a roof deck 14 formed from metal decking panels 16. The insulation panels 24 are positioned such that second surface 40 thereof is aligned properly with corresponding features of the metal decking panels 16—such as aligning flute filler portion 34 of insulation panels 24 with low flutes 22 of metal decking panels 16. Also as STEP 50 the insulation panels 24 are affixed to metal decking panels 16, such as via adhesive or other appropriate fastening mechanisms. A finishing membrane 26 is then attached to the insulation panels 24 at STEP 52 via a known technique, such as by ballasting, mechanical attachment, or adhesives, for example. A finished roof insulating system 10 may thus be formed by method 42 having reduced materials costs and installation costs associated therewith and that provides increased efficiency of the R value associated with the system.

While embodiments of the invention set forth above describe insulating panels being positioned on the metal decking panels on the top/outside surface of the panel (as would be to case for installing a TPO type roof), it is recognized that additional embodiments of the invention are directed to insulating panels positioned on the bottom/inside surface of the metal decking panel (or metal siding panels), such that insulation panels can be utilized on the inside of a structure. That is, the insulation board portion of the insulation panel body may be suitable for presenting a finished out appearance to the interior of the structure. In such an embodiment, the ridges on the top surface of the metal decking panel would be flutes on the bottom surface (i.e., the high flutes would be low flutes) and the valleys on the top surface of the metal decking panel would be ridges on the bottom surface (i.e., the low flutes would be high flutes).

Beneficially, embodiments of the invention thus provide an insulation panel form fitted to the specific metal panel type to which it is to be applied. The insulation panel is produced in an exact form matching the metal panel for which is it being used and is then attached through the use of adhesive for fully adhered attachment or through the use of fasteners for the mechanically attachment of product. The benefits of the use of this product over the current two-step multiple product method (i.e., applying separate flute fillers and insulation boards) used in the roofing industry includes costs savings benefits in the form of reduced material cost (a cost reduction of approximately $24 per roofing square (100 Sq. Ft.)), reduction of labor expense in the installation process by as much as 10%, and the increased efficiency of the R value associated with the product, since there would be no open spaces between the molded insulating panels and the metal panels. The molded insulating panels can be used on any metal panel for insulating either on top/outside portion of the panel (as would be to case for installing a TPO type roof) or from the inside of the of the structure, which could provide insulation for either roof or wall panels. Additional benefits include building appearance, since such insulating panels can give the finished out appearance to the interior of insulated wall panels.

Therefore, according to one embodiment of the invention, an insulation panel for a metal roof includes a body formed of a moldable insulating material, the body having a first surface facing away from a metal roof panel to which the body is to be applied on and a second surface opposed from the first surface and configured to mate with the metal roof panel to which the body is to be applied on, wherein the second surface of the body comprises a non-planar surface shaped to conform to a profile of the metal roof panel to which the body is to be applied on.

According to another embodiment of the invention, a roofing system includes a metal roof having at least one non-planar surface and an insulation panel applied to the non-planar surface of the metal roof, the insulation panel comprising a body formed of a moldable insulating material and including a planar first surface facing away from the metal roof and a second surface opposed from the first surface and configured to mate with the metal roof, wherein the second surface of the body comprises a non-planar surface shaped to conform to a profile of the non-planar surface of the metal roof.

According to yet another embodiment of the invention, a method of fabricating an insulation panel for a metal roof includes determining a profile of a metal decking panel to which the insulation panel is to be applied and fabricating the insulation panel via a molding process and such that the insulation panel is form-fitted to the profile of the metal decking panel, with the insulation panel being fabricated to include a planar first surface facing away from the metal decking panel to which the insulation panel is to be applied on and a non-planar second surface opposed from the first surface and configured to be form-fitted with the metal decking panel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An insulation panel for a metal roof, the insulation panel comprising:
a body formed of a moldable insulating material, the body including:
a first surface facing away from a metal roof panel to which the body is to be applied on; and
a second surface opposed from the first surface and configured to mate with the metal roof panel to which the body is to be applied on;
wherein the second surface of the body comprises a non-planar surface shaped to conform to a profile of the metal roof panel to which the body is to be applied on.

2. The insulation panel of claim 1 wherein the first surface comprises a planar surface that functions as an insulation decking board.

3. The insulation panel of claim 2 wherein the non-planar second surface comprises a plurality of flute fillers extending outwardly from a base of the second surface, the plurality of flute fillers configured to conform to respective flutes formed in the metal roof panel.

4. The insulation panel of claim 3 wherein the plurality of flute fillers comprises a plurality of linear protrusions arranged in a spaced apart fashion.

5. The insulation panel of claim 3 wherein the plurality of flute fillers are formed integrally with the base as a single body of the insulation panel.

6. The insulation panel of claim 1 wherein the body is formed of one of expanded polystyrene (EPS), extruded polystyrene (XPS), or polyisocyanurate (Poly ISO).

7. The insulation panel of claim 6 wherein the body comprises a molded panel formed from the one of EPS, XPS, or Poly ISO.

8. A roofing system comprising:
a metal roof comprising at least one non-planar surface; and
an insulation panel applied to the metal roof and comprising a body formed of a moldable insulating material, the body including:
a first surface facing away from the metal roof, the first surface comprising a planar surface; and
a second surface opposed from the first surface and configured to mate with the metal roof;
wherein the second surface of the body comprises a non-planar surface shaped to conform to a profile of the non-planar surface of the metal roof.

9. The roofing system of claim 8 wherein the non-planar surface of the metal roof comprises a plurality of ridges between which a plurality flutes are formed, and wherein the non-planar surface of the insulation panel conforms to a profile of the metal roof, with the flute fillers interfitting with the flutes.

10. The roofing system of claim 9 wherein the body of the insulation panel comprises:
an insulation board forming the first surface of the body; and
a plurality of flute fillers formed on the insulation board and extending outwardly therefrom on the second surface of the body, with the plurality of flute fillers forming the non-planar second surface of the body;
wherein the insulation board and the flute fillers are integrally formed as a single body of the insulation panel.

11. The roofing system of claim 10 wherein the insulation board and flute fillers are formed of a same insulating material.

12. The roofing system of claim 10 wherein the plurality of flute fillers comprises a plurality of linear protrusions arranged in a spaced apart fashion.

13. The roofing system of claim 8 wherein the body is formed of one of expanded polystyrene (EPS), extruded polystyrene (XPS), or polyisocyanurate (Poly ISO).

14. The roofing system of claim 13 wherein the body comprises a molded panel formed from the one of EPS, XPS, or Poly ISO.

15. The roofing system of claim 8 further comprising a finishing membrane applied to the planar first surface of the insulation panel body.

16. The roofing system of claim 9 wherein the finishing membrane comprises a thermoplastic polyolefin (TPO) membrane.

17. A method of fabricating an insulation panel for a metal roof, the method comprising:
determining a profile of a metal decking panel to which the insulation panel is to be applied; and
fabricating the insulation panel via a molding process and such that the insulation panel is form-fitted to the profile of the metal decking panel, with the insulation panel being fabricated to include:
a planar first surface facing away from the metal decking panel to which the insulation panel is to be applied on; and
a non-planar second surface opposed from the first surface and configured to be form-fitted with the metal decking panel.

18. The method of claim 17 wherein the planar first surface is formed as a planar insulation board capable of having a finishing membrane applied thereto.

19. The method of claim 18 wherein the non-planar second surface comprises a plurality of flute fillers formed on the insulation board and extending outwardly therefrom on the second surface of the insulation panel, with the plurality of flute fillers configured to fit within and be form-fitted to a plurality of flutes on the metal decking panel.

20. The method of claim 17 wherein the insulation panel is molded from one of expanded polystyrene (EPS), extruded polystyrene (XPS), or polyisocyanurate (Poly ISO).
